(19) United States
(12) Patent Application Publication
(10) Pub. No.: US 2017/0154238 A1
(43) Pub. Date: Jun. 1, 2017

(54) METHOD AND ELECTRONIC DEVICE FOR SKIN COLOR DETECTION

(71) Applicants: Le Holdings (Beijing) Co., Ltd., Beijing (CN); Le Shi Zhi Xin Electronic Technology (Tian Jin) Limited, Beijing (CN)

(72) Inventor: Yanjie LI, Beijing (CN)

(21) Appl. No.: 15/247,488

(22) Filed: Aug. 25, 2016

Related U.S. Application Data
(63) Continuation of application No. PCT/CN2016/082540, filed on May 18, 2016.

(30) Foreign Application Priority Data
Nov. 26, 2015 (CN) 201510844460.7
May 18, 2016 (CN) PCT/CN2016/082540

(51) Int. Cl. G06K 9/46; H04N 1/60; G06T 7/00; G06T 7/40

(52) U.S. Cl. CPC G06K 9/4652; G06T 7/408; H04N 1/6016; G06T 7/0081; G06T 2207/20076

(57) ABSTRACT

The present disclosure discloses a method and a device for skin color detection. The method includes: reading an RGB image, and converting the RGB image from an RGB color space to an r-g color space, and obtaining an image to be detected; traversing and reading each pixel in the image to be detected, and calculating a first probability density of the pixel under a skin Gaussian mixture model and a second probability density of the pixel under a non-skin Gaussian mixture model according to a pre-established Gaussian mixture model; calculating the posteriori probability of the pixel belonging to a skin region according to the first probability density and the second probability density of the pixel; and attributing the pixel to the skin region when determining that the posteriori probability is greater than a preset posteriori probability threshold. Effective skin color detection under a case of a few samples is implemented.

### CROSS-REFERENCE TO RELATED APPLICATIONS

This application is a continuation of PCT international application No. PCT/CN2016/082540, filed May 18, 2016, which claims priority to Chinese Patent Application No. 2015108444607, filed Nov. 26, 2015, the entire contents of which are incorporated herein by reference.

### TECHNICAL FIELD

This relates to the field of computer vision, and, more particularly, to a method and a device for skin color detection.

### BACKGROUND

In a variety of machine vision systems associated with people, skin color detection is increasingly gaining in importance. For example, the position of hands in an image needs to be acquired firstly in a gesture-based human-machine interaction system. While the most common method at present is to acquire gesture information by skin color detection. And the most common segmentation method for segmenting the hands from the image is segmentation based on the skin color.

Methods for skin color detection are divided into two basic types according to that whether an imaging process is involved: a statistics-based method and a physics-based method. The statistics-based method for skin color detection mainly performs skin color detection through establishing a skin color statistical model, and mainly includes two steps: color space conversion and skin color modeling; while the physics-based method introduces the interaction between illumination and skin to skin color detection, and performs skin color detection through studying a skin color reflection model and spectral characteristics.

In the static modeling of the statistics-based method for skin color detection, histogram-based skin color detection is the simplest, fast and most effective in the method for skin color detection. However, it needs to collect a large number of samples for statistics so that preferable segmentation effects can be obtained only, while sample collection is a time-consuming and labourious job.

Therefore, it is highly desirable to propose an effective method for skin color detection.

### SUMMARY

The object of the present disclosure is to provide a method and a device for skin color detection, for solving the defect in the prior art that a large number of samples need to be collected so that preferable segmentation effects can be obtained only, and implementing effective skin color detection.

To fulfill the foregoing object, the present disclosure adopts the following technical solutions.

According to a first aspect, some embodiments of the present disclosure provide a method for skin color detection, including:

reading an RGB image, and converting the RGB image from an RGB color space to an r-g color space, and obtaining an image to be detected;

traversing and reading each pixel in the image to be detected, and calculating a first probability density of the pixel under a skin Gaussian mixture model and a second probability density of the pixel under a non-skin Gaussian mixture model according to a pre-established Gaussian mixture model;

calculating the posteriori probability of the pixel belonging to a skin region according to the first probability density and the second probability density of the pixel; and

attributing the pixel to the skin region when determining that the posteriori probability is greater than a preset posteriori probability threshold.

According to a second aspect, some embodiments of the present disclosure provide an electronic device for skin color detection, including:

at least one processor; and

a memory communicably connected with the at least one processor for storing instructions executable by the at least one processor, wherein execution of the instructions by the at least one processor causes the at least one processor to:

read an RGB image and convert the RGB image from an RGB color space to an r-g color space, and obtain an image to be detected;

traverse and read each pixel in the image to be detected, and calculate a first probability density of the pixel under a skin Gaussian mixture model and a second probability density of the pixel under a non-skin Gaussian mixture model according to a pre-established Gaussian mixture model; and calculate the posteriori probability of the pixel belonging to a skin region according to the first probability density and the second probability density of the pixel; and

attribute the pixel to the skin region when determining that the posteriori probability is greater than a preset posteriori probability threshold.

Compared with the prior art, the technical effects that may be obtained by the present application include:

The method and device for skin color detection provided by some embodiments of the present disclosure limit the influences of illumination on skin color detection to some degree by converting the RGB image into an r-g image; meanwhile, some embodiments of the present disclosure judge the posteriori probability of each pixel in the image to be detected belonging to the skin region through establishing the skin Gaussian mixture model and the non-skin Gaussian mixture model, which have preferable skin color detection effects when the quantity of samples is small, and improve the skin color detection efficiency.

### BRIEF DESCRIPTION OF THE DRAWINGS

In order to explain the technical solutions in some embodiments of the disclosure or in the prior art more clearly, the drawings used in the descriptions of some embodiments or the prior art will be simply introduced hereinafter. It is apparent that the drawings described hereinafter are merely some embodiments of the disclosure, and those skilled in the art may also obtain other drawings according to these drawings without going through creative work.

FIG. 1 is a technical flow chart of a first embodiment of the present disclosure;

FIG. 2 is a technical flow chart of a second embodiment of the present disclosure;

FIG. 3 is a structural diagram of a device of a third embodiment of the present disclosure; and

FIG. 4 is a block diagram of an electronic device in accordance with some embodiments.

### DETAILED DESCRIPTION

The main idea of the present disclosure is to judge the posteriori probability of each pixel in the image to be detected belonging to the skin region through converting the RGB image into the r-g image and through establishing the skin Gaussian mixture model and the non-skin Gaussian mixture model at the same time.

To make the objects, technical solutions and advantages of some embodiments of the present disclosure more clearly, the technical solutions of the present disclosure will be clearly and completely described hereinafter with reference to some embodiments and drawings of the present disclosure. Apparently, some embodiments described are merely partial embodiments of the present disclosure, rather than all embodiments. Other embodiments derived by those having ordinary skills in the art on the basis of some embodiments of the disclosure without going through creative efforts shall all fall within the protection scope of the present disclosure.

The technical solutions provided by some embodiments of the present disclosure may be used in any technical field that needs skin detection or skin color segmentation, for example, human face detection, gesture recognition, smart eroticism identification, or the like. Moreover, it should be illustrated that some embodiments of the present disclosure do not exist alone, and may be mutual complemented or combined; for example, the first embodiment is an example for using a Gaussian mixture model to perform skin color detection, the second embodiment is an example of a process for establishing a Gaussian mixture model, and the mutual combination of the two embodiments is more detailed description of some embodiments of the present disclosure.

### FIRST EMBODIMENT

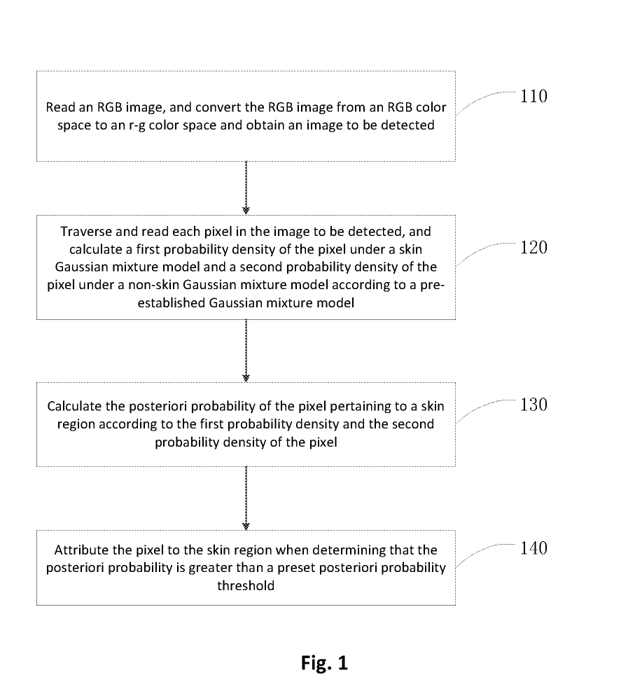

FIG. 1 is a technical flow chart of the first embodiment of the present disclosure. With reference to FIG. 1, a method for skin color detection of the embodiment of the present disclosure mainly includes the following steps.

In step 110: an RGB image is read, and the RGB image is converted from an RGB color space to an r-g color space, and obtaining an image to be detected.

In the embodiment of the present disclosure, the RGB image is converted from the RGB color space to the r-g color space adopting a formula as follows:

$$r = \frac{R}{R + G + B}$$

$$g = \frac{G}{R + G + B}$$

$$b = 1 - r - g$$

wherein, R is the red value of the pixel, G is the green value of the pixel, and B is the blue value of the pixel; r, g and b are the corresponding color values of the pixel after conversion respectively.

The RGB color space herein refers to obtaining various colors through changing three color channels including red (R), green (G) and blue (B) as well as mutual overlaying of the channels. Usually, RGB has 256 brightness levels respectively, which are digitally represented from 0, 1, 2, . . . , till 255. One group of RGB color values specify the relative brightness of three-primary colors including red, green and blue, and generate one specific color for displaying. i.e., any color can be recorded and expressed by one group of RGB values. For example, the RGB values corresponding to a certain pixel are (149, 123, 98), and the color of the pixel is the overlaying of the three colors RGB with different brightness.

In the embodiment of the present disclosure, the corresponding RGB values of each pixel in the picture can be directly obtained using OpenCv, wherein implementation codes are as follows:
CvScalar p;
p=cvGet2D(ImageIn, j, i);
double a=p.val[0];
double b=p.val[1];
double c=p.val[2];

wherein, i and j are horizontal and vertical coordinates of the pixel on the image respectively; and channels 0, 1 and 2 are corresponding to the brightness values of the three colors including blue, green and red respectively.

In the embodiment of the present disclosure, converting the color space from RGB to r-g is actually a normalization process to the RGB colors. During the normalization process, when a certain pixel produces changes of color channel (R, G, B) values due to the influences of illumination or shadow, a numerator and a denominator in a normalization formula are changed at the same time, and a normalization value obtained is not floated a lot actually. This conversion manner removes illumination information from the image, thus being capable of weakening the influences of illumination.

For example: the pixel value of a pixel A at T1 moment before normalization is RGB (30, 60, 90); at T2 moment, the color values of the three color channels (RGB) are changed due to the influences of illumination, and the pixel value of the pixel A changes to RGB (60, 120, 180).

After the color space is converted to the r-g space through the normalization formula, the pixel value of the A at T1 moment is rgb(⅙, ⅓, ½); and the pixel value of the pixel A at T2 moment is rgb(⅙, ⅓, ½). It follows that the normalized RGB values at T1 and T2 moment do not change.

In step 120: each pixel in the image to be detected is traversed and read, and a first probability density of the pixel under a skin Gaussian mixture model and a second probability density of the pixel under a non-skin Gaussian mixture model are calculated according to a pre-established Gaussian mixture model.

The Gaussian mixture model GMM which is also called as MOG, is the extension of a single Gaussian model, and uses m (substantially 3 to 10) Gaussian models to characterize the characteristics of each pixel in the image.

The formula expresses of the single Gaussian model is shown below:

$$p ( x ) = ϕ ( x ; a , S ) = \frac{1}{{( 2 π )}^{d / 2} {\vert S \vert}^{1 / 2}} exp \{ - \frac{1}{2} {( x - a )}^{T} {S}^{- 1} ( x - a ) \}$$

wherein, x belongs to a d-dimension euclidean space, a is the mean vector of the single Gaussian model, S is the covariance matrix of the single Gaussian model, O^{T} represents the transpose operation of the matrix, and O⁻¹ represents the inverse operation of the matrix.

The formula of the Gaussian mixture model is formed by accumulating m single Gaussian models according to the weight coefficients, and is reflected by a formula as follows:

$$p ( x ; {a}_{k} , {S}_{k} , {π}_{k} ) = {\sum }_{k = 1}^{m} {π}_{k} {p}_{k} ( x ) , {π}_{k} \geq 0 , {\sum }_{k = 1}^{m} {π}_{k} = 1$$

wherein, πₖ is the weight coefficient of the k Gaussian model, m is the preset number of Gaussian models, and pₖ(x) is the k single Gaussian model. Wherein, the formula expression of the k single Gaussian model is as follows:

$${p}_{k} ( x ) = ϕ ( x ; {a}_{k} , {S}_{k} ) = \frac{1}{{( 2 π )}^{d / 2} {\vert {S}_{k} \vert}^{1 / 2}} exp \{ - \frac{1}{2} {( x - {a}_{k} )}^{T} {S}_{k}^{- 1} ( x - {a}_{k} ) \}$$

As described above, x belongs to a d-dimension euclidean space, m is the preset number of Gaussian models, pₖ(x) is the probability density of the k Gaussian model, aₖ is the mean vector of the k Gaussian model, Sₖ is the covariance matrix of the k Gaussian model, and πₖ is the weight coefficient of the k Gaussian model.

It should be illustrated that the actual calculation results of p(x; aₖ, Sₖ, πₖ) and pₖ(x) characterize the probability density of x under a corresponding model.

In the embodiment of the present disclosure, a Gaussian mixture model is established respectively for skin pixel and non-skin pixels, and the formula expresses of the two models are the same, while the difference is parameters in the models, i.e., the mean factor aₖ and the covariance matrix Sₖ are different.

For each pixel in the image to be detected, the embodiment of the present disclosure calculates a first probability density thereof under a skin Gaussian mixture model, and calculates a second probability density thereof under a non-skin Gaussian mixture model, until all the pixels are traversed.

In the embodiment of the present disclosure, the traversing process may either be to traverse the pixels one by one by rows and lines, or randomly select one pixel, judge whether the pixel is the pixel of a skin region, and traverse the pixels in a neighborhood thereof with a certain size firstly if the pixel is the pixel of the skin region. The traversing process is not limited by the present disclosure.

When the mean vector of the skin Gaussian mixture model is aₖ₁, the covariance matrix is Sₖ₁, and the weight coefficient respectively corresponding to a plurality of single Gaussian models is πₖ₁,

$${p}_{skin} ( x ; {a}_{k 1} , {S}_{k 1} , {π}_{k 1} ) = {\sum }_{k 1 = 1}^{m} {π}_{k 1} {p}_{k 1} ( x ) , {π}_{k 1} \geq 0 , {\sum }_{k 1 = 1}^{m} {π}_{k 1} = 1$$

When the mean vector of the non-skin Gaussian mixture model is aₖ₂, the covariance matrix is Sₖ₂, and the weight coefficient respectively corresponding to a plurality of single Gaussian models is πₖ₂,

$${p}_{non \text{-} skin} ( x ; {a}_{k 2} , {S}_{k 2} , {π}_{k 2} ) = {\sum }_{k 2 = 1}^{m} {π}_{k 2} {p}_{k 2} ( x ) , {π}_{k 2} \geq 0 , {\sum }_{k 2 = 1}^{m} {π}_{k 2} = 1$$

In step 130: the posteriori probability of the pixel belonging to the skin region is calculated according to the first probability density and the second probability density of the pixel.

In the embodiment of the present disclosure, the calculation formula of the posteriori probability is as follows:

$$P = \frac{{p}_{skin}}{{p}_{skin} + {p}_{non \text{-} skin}}$$

wherein, P is the value of the posteriori probability, pₛₖᵢₙ is the first probability density; and pₙₒₙ₋ₛₖᵢₙ is the second probability density.

In step 140: the pixel is attributed to the skin region when determining that the posteriori probability is greater than a preset posteriori probability threshold.

Preferably, the posteriori probability threshold is set as 0.5 in the embodiment of the present disclosure, i.e., the pixel corresponding to the posteriori probability is judged to belong to the skin region when the value of the posteriori probability exceeds 0.5. The posteriori probability threshold 0.5 is an empirical value judged and obtained by a large number of experiments. If the posteriori probability of a pixel belonging to a skin pixel exceeds 0.5, then the pixel belongs to the skin region of the image. Certainly, the posteriori probability threshold may also be dynamically adjusted according to different picture samples, and the present disclosure will not be limited to this.

In the embodiment, the influences of illumination on skin color detection are controlled to some degree by converting the RGB image into the r-g image; meanwhile, with respect to the defect in the prior art that a large number of samples need to be obtained for histogram-based skin color detection, the embodiment of the present disclosure also has preferable skin color detection effects when the quantity of samples is small by combining with the Gaussian mixture model and calculating the posteriori probability of each pixel belonging to the skin region, and improves the skin color detection efficiency.

### SECOND EMBODIMENT

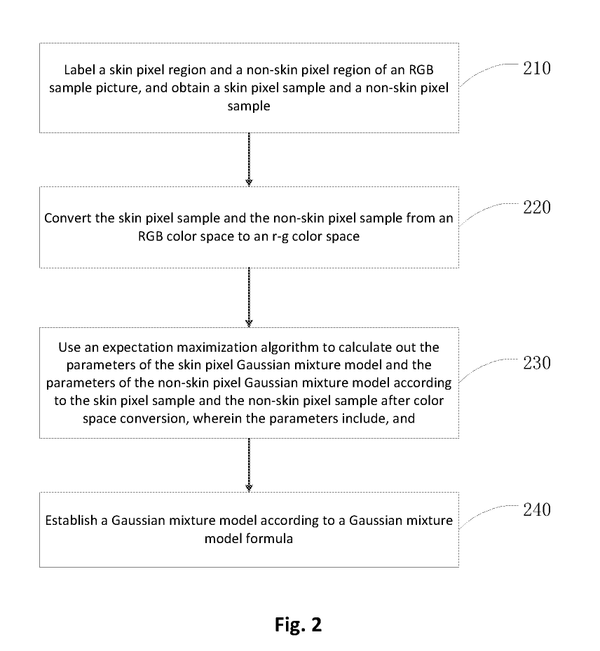

FIG. 2 is a technical flow chart of the second embodiment of the present disclosure. With reference to FIG. 2, in a method for skin color detection of the embodiment of the present disclosure, establishing a Gaussian mixture model mainly include the following steps.

In step 210: a skin pixel region and a non-skin pixel region of an RGB sample picture are labeled, and obtain a skin pixel sample and a non-skin pixel sample.

In the embodiment of the present disclosure, the RGB sample picture is labeled firstly, wherein the RGB sample image may be artificially labeled, for distinguishing the skin region and the non-skin region in the picture, thus obtaining the skin pixel sample and the non-skin pixel sample. Classifying the samples in advance is beneficial for improving the efficiency of a subsequent EM algorithm for calculating the parameters of a Gaussian mixture model and the degree of closeness of the parameters with that of an actual model.

In step 220: the skin pixel sample and the non-skin pixel sample are converted from an RGB color space to an r-g color space.

The conversion manner in this step is the same as that described in the first embodiment, adopting a formula as follows:

$$\begin{matrix}r = \frac{R}{R + G + B} \\ g = \frac{G}{R + G + B} \\ b = 1 - r - g\end{matrix}$$

wherein, R is the red value of the pixel, G is the green value of the pixel, and B is the blue value of the pixel; r, g and b are the corresponding color values of the pixel after conversion respectively.

In step 230: an expectation maximization algorithm is used to calculate out the parameters of the skin pixel Gaussian mixture model and the parameters of the non-skin pixel Gaussian mixture model according to the skin pixel sample and the non-skin pixel sample after color space conversion, wherein the parameters include aₖ, Sₖ and πₖ.

The Gaussian mixture model is the overlaying of a plurality of single Gaussian models. In the Gaussian mixture model, the weight coefficients of various single Gaussian models are different, i.e., the data in the Gaussian mixture model is generated from several single Gaussian models. The number m of the single Gaussian models needs to be set in advance, and πₖ is the weight coefficient of each single Gaussian model namely.

In statistics calculation, the expectation maximization (EM) algorithm is an algorithm for seeking the maximum likelihood estimation or the maximum posterior estimation of parameters in a probabilistic (probabilistic) model, wherein the probabilistic model depends on latent variables (Latent Variable) that cannot be observed. When partial data is missing or cannot be observed, the EM algorithm provides an effective iterator for calculating the maximum likelihood estimation of these data. Each iteration includes two steps: an expectation (Expectation) step and a maximization (Maximization) step; therefore, this algorithm is called as EM algorithm. The EM algorithm is a very mature algorithm and the derivation process thereof is complicated, and will not be elaborated in the embodiment of the present disclosure.

In step 240: a Gaussian mixture model is established according to a Gaussian mixture model formula.

The mean vector aₖ₁ and the covariance matrix Sₖ₁ of the skin Gaussian mixture model and the weight coefficient πₖ₁ respectively corresponding to a plurality of single Gaussian models can be calculated out according to the labeled skin pixel sample and in combination with the EM algorithm. Substituting the parameters into the Gaussian mixture model formula may obtain the skin Gaussian mixture model as follows:

$${p}_{skin} ( x ; {a}_{k 1} , {S}_{k 1} , {π}_{k 1} ) = {\sum }_{k 1 = 1}^{m} {π}_{k 1} {p}_{k 1} ( x ) , {π}_{k 1} \geq 0 , {\sum }_{k 1 = 1}^{m} {π}_{k 1} = 1$$

The mean vector aₖ₂ and the covariance matrix Sₖ₂ of the non-skin Gaussian mixture model and the weight coefficient πₖ₂ respectively corresponding to a plurality of single Gaussian models can be calculated out according to the labeled non-skin pixel sample and in combination with the EM algorithm. The non-skin Gaussian mixture model is obtained as follows:

$${p}_{non \text{-} skin} ( x ; {a}_{k 2} , {S}_{k2} , {π}_{k 2} ) = {\sum }_{k 2 = 1}^{m} {π}_{k 2} {p}_{k2} ( x ) , {π}_{k2} \geq 0 , {\sum }_{k 2 = 1}^{m} {π}_{k 2} = 1$$

When a new picture to be detected is read, each pixel of the picture to be detected is read after color space conversion, and the pixels are substituted into the two models above, and the pₛₖᵢₙ and pₙₒₙ₋ₛₖᵢₙ of the pixels are calculated respectively.

In the embodiment skin pixel and non-skin pixel Gaussian mixture models are established by labeling the skin regions and non-skin regions of a few sample pictures and assisted with the EM algorithm; compared with the histogram-based skin color detection in the prior art, the embodiment does not need a large number of training samples, saves various resources, and improves the skin color detection efficiency.

### THIRD EMBODIMENT

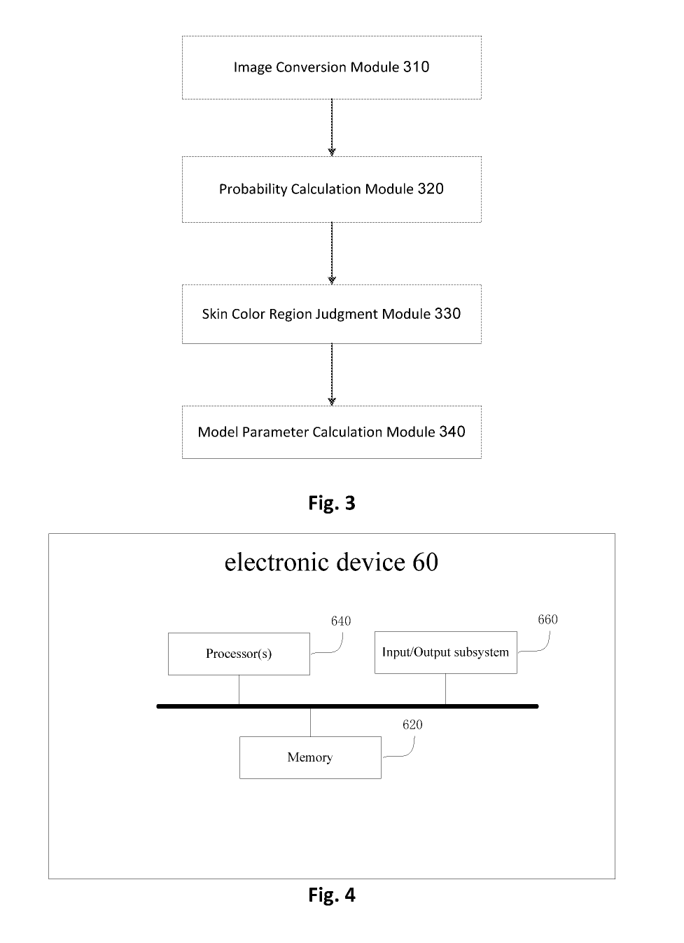

FIG. 3 is a structural diagram of a device for skin color detection according to the embodiment of the present disclosure. With reference to FIG. 3, the device for skin color detection mainly includes the several large modules as follows: an image conversion module image conversion module 310, a probability calculation module 320 and a skin color region judgment module 330.

The image conversion module 310 is configured to read an RGB image and convert the RGB image from an RGB color space to an r-g color space, and obtain an image to be detected.

The probability calculation module 320 is connected with the image conversion module 310 and is configured to traverse and read each pixel in the image to be detected, and calculate a first probability density of the pixel under a skin Gaussian mixture model and a second probability density of the pixel under a non-skin Gaussian mixture model according to a pre-established Gaussian mixture model; and configured to calculate the posteriori probability of the pixel belonging to a skin region according to the first probability density and the second probability density of the pixel.

The skin color region judgment module 330 is connected with the probability calculation module 320 and is configured to attribute the pixel to the skin region when determining that the posteriori probability is greater than a preset posteriori probability threshold.

Further, the image conversion module 310 is configured to convert the RGB image from the RGB color space to the r-g color space adopting a formula as follows:

$$\begin{matrix}r = \frac{R}{R + G + B} \\ g = \frac{G}{R + G + B} \\ b = 1 - r - g\end{matrix}$$

wherein, R is the red value of the pixel, G is the green value of the pixel, and B is the blue value of the pixel; r, g and b are the corresponding color values of the pixel after conversion respectively.

Further, the probability calculation module 320 is configured to: calculate the posteriori probability adopting a formula as follows:

$$P = \frac{{p}_{skin}}{{p}_{skin} + {p}_{non \text{-} skin}}$$

wherein, P is the value of the posteriori probability, pₛₖᵢₙ is the first probability density; and pₙₒₙ₋ₛₖᵢₙ is the second probability density.

Further, the probability calculation module 320 is also configured to calculate the first probability density and the second probability density adopting a formula as follows:

$$p ( x ; {a}_{k} , {S}_{k} , {π}_{k} ) = {\sum }_{k = 1}^{m} {π}_{k} {p}_{k} ( x ) , {π}_{k} \geq 0 , {\sum }_{k = 1}^{m} {π}_{k} = 1 , \\ {p}_{k} ( x ) = ϕ ( x ; {a}_{k} , {S}_{k} ) = \frac{1}{{( 2 π )}^{d / 2} {\vert {S}_{k} \vert}^{1 / 2}} exp \{ - \frac{1}{2} {( x - {a}_{k} )}^{T} {S}_{k}^{- 1} ( x - {a}_{k} ) \}$$

wherein, p(x; aₖ, Sₖ, πₖ)is the probability density of the Gaussian mixture model, x belongs to a d-dimension euclidean space, m is the preset number of Gaussian models, pₖ(x) is the probability density of the k Gaussian model, aₖ is the mean vector of the k Gaussian model, Sₖ is the covariance matrix of the k Gaussian model, and πₖ is the weight coefficient of the K Gaussian model.

The device further includes a model parameter calculation module 340, and the model parameter calculation module 340 is configured to:

label a skin pixel region and a non-skin pixel region of an RGB sample image, and obtaining a skin pixel sample and a non-skin pixel sample;

convert the skin pixel sample and the non-skin pixel sample from the RGB color space to the r-g color space; and

use an expectation maximization algorithm to calculate out the parameters of the skin pixel Gaussian mixture model and the parameters of the non-skin pixel Gaussian mixture model according to the skin pixel sample and the non-skin pixel sample after color space conversion, wherein the parameters include aₖ, Sₖ and πₖ.

In the embodiment, the picture to be detected is converted from the RGB color space to the r-g color space through the image conversion module 310, which avoids the influences of illumination on skin color detection to some degree; meanwhile, the probability calculation module 320 calculates the probability and the posteriori probability of each pixel in the image to be detected belonging to the skin region and a non-skin region respectively according to the pre-established Gaussian mixture model, so that the skin color detection is more effective, and preferable skin color detection effects can also be achieved without a large number of samples.

Attention is now directed toward embodiments of an electronic device. FIG. 4 is a block diagram illustrating an electronic device 60. The electronic device may include memory 620 (which may include one or more computer readable storage mediums), at least one processor 640, and input/output subsystem 660. These components may communicate over one or more communication buses or signal lines. It should be appreciated that the electronic device 60 may have more or fewer components than shown, may combine two or more components, or may have a different configuration or arrangement of the components. The various components may be implemented in hardware, software, or a combination of both hardware and software.

The memory 620, as a non-volatile computer readable storage medium, may be configured to store non-volatile software programs, non-volatile computer executable programs and modules, for example, the program instructions/modules corresponding to the method for skin color detection in some embodiments of the present application. The non-volatile software programs, instructions and modules stored in the memory 620, when being executed, cause the processor 640 to perform various function applications and data processing, that is, performing the method for skin color detection in the above method embodiments.

The memory 620 may also include a program storage area and a data storage area. The program storage area may store an operating system and an application implementing at least one function. The data storage area may store data created according to use of the device for skin color detection. In addition, the memory 620 may include a high speed random access memory, or include a non-volatile memory, for example, at least one disk storage device, a flash memory device, or another non-volatile solid storage device. In some embodiments, the memory 620 optionally includes memories remotely configured relative to the at least one processor 640. These memories may be connected to the device for skin color detection over a network. The above examples include, but not limited to, the Internet, Intranet, local area network, mobile communication network and a combination thereof.

One or more modules are stored in the memory 620, and when being executed by the one or more processors 640, perform the method for skin color detection in any of the above method embodiments.

The product may perform the method according to the embodiments of the present application, has corresponding function modules for performing the method, and achieves the corresponding beneficial effects. For technical details that are not illustrated in detail in this embodiment, reference may be made to the description of the methods according to the embodiments of the present application.

Moreover, executable instructions for performing various functions may be included in a non-transitory computer readable storage medium or other computer program product configured for execution by at least one processor. Some embodiments of the present disclosure also provide a non-transitory computer-readable storage medium storing executable instructions that, when executed by an electronic device with a touch-sensitive display, cause the electronic device to perform the method as shown in FIG. 1 or FIG. 2.

The electronic device in the embodiments of the present application is practiced in various forms, including, but not limited to:

(1) a mobile communication device: which has the mobile communication function and is intended to provide mainly voice and data communications; such terminals include: a smart phone (for example, an iPhone), a multimedia mobile phone, a functional mobile phone, a low-end mobile phone or the like;

(2) an ultra mobile personal computer device: which pertains to the category of personal computers and has the computing and processing functions, and additionally has the mobile Internet access feature; such terminals include: a PDA, an MID, an UMPC device or the like, for example, an iPad;

(3) a portable entertainment device: which displays and plays multimedia content; such devices include: an audio or video player (for example, an iPod), a palm game machine, an electronic book, and a smart toy, and a portable vehicle-mounted navigation device;

(4) a server: which provides services for computers, and includes a processor, a hard disk, a memory, a system bus or the like; the server is similar to the general computer in terms of architecture; however, since more reliable services need to be provided, higher requirements are imposed on the processing capability, stability, reliability, security, extensibility, manageability or the like of the device; and

(5) another electronic device having the data interaction function.

The device embodiments described above are only exemplary, wherein the units illustrated as separation parts may either be or not physically separated, and the parts displayed by units may either be or not physical units, i.e., the parts may either be located in the same place, or be distributed on a plurality of network units. A part or all of the modules may be selected according to an actual requirement to achieve the objectives of the solutions in some embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer apparatus (which may be a personal apparatus, a server, or a network device so on) to execute the method according to each embodiment or some parts of some embodiments.

It should be finally noted that the above embodiments are only configured to explain the technical solutions of the present disclosure, but are not intended to limit the present disclosure. Although the present disclosure has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the technical solutions of some embodiments of the present disclosure.

What is claimed is:

1. A method for skin color detection, at an electronic device, comprising:
reading an RGB image, and converting the RGB image from an RGB color space to an r-g color space, and obtaining an image to be detected;
traversing and reading each pixel in the image to be detected, and calculating a first probability density of the pixel under a skin Gaussian mixture model and a second probability density of the pixel under a non-skin Gaussian mixture model according to a pre-established Gaussian mixture model;
calculating the posteriori probability of the pixel belonging to a skin region according to the first probability density and the second probability density of the pixel; and
attributing the pixel to the skin region when determining that the posteriori probability is greater than a preset posteriori probability threshold.

2. The method according to claim 1, wherein the converting the RGB image from the RGB color space to the r-g color space further comprises:
converting the RGB image from the RGB color space to the r-g color space using a formula as follows:
$$\begin{matrix}r = \frac{R}{R + G + B} \\ g = \frac{G}{R + G + B} \\ b = 1 - r - g\end{matrix}$$
wherein, R is the red value of the pixel, G is the green value of the pixel, and B is the blue value of the pixel; r, g and b are the corresponding color values of the pixel after conversion respectively.

3. The method according to claim 1, wherein the calculating the posteriori probability of the pixel belonging to the skin region according to the first probability density and the second probability density of the pixel further comprises:
calculating the posteriori probability adopting a formula as follows:
$$P = \frac{{p}_{skin}}{{p}_{skin} + {p}_{non \text{-} skin}}$$
wherein, P is the value of the posteriori probability, pₛₖᵢₙ is the first probability density; and pₙₒₙ₋ₛₖᵢₙ is the second probability density.

4. The method according to claim 3, wherein the calculating the first probability density of the pixel under the skin Gaussian mixture model and the second probability density of the pixel under the non-skin Gaussian mixture model according to the pre-established Gaussian mixture model further adopts a formula as follows:
$$p ( x ; {a}_{k} , {S}_{k} , {π}_{k} ) = {\sum }_{k = 1}^{m} {π}_{k} {p}_{k} ( x ) , {π}_{k} \geq 0 , {\sum }_{k = 1}^{m} {π}_{k} = 1 , \\ {p}_{k} ( x ) = ϕ ( x ; {a}_{k} , {S}_{k} ) = \frac{1}{{( 2 π )}^{d / 2} {\vert {S}_{k} \vert}^{1 / 2}} exp \{ - \frac{1}{2} {( x - {a}_{k} )}^{T} {S}_{k}^{- 1} ( x - {a}_{k} ) \}$$
wherein, p(x; aₖ, Sₖ, πₖ) is the probability density of the Gaussian mixture model, x belongs to a d-dimension euclidean space, m is the preset number of Gaussian models, pₖ(x) is the probability density of the k Gaussian model, aₖ is the mean vector of the k Gaussian model, Sₖ is the covariance matrix of the k Gaussian model, and πₖ is the weight coefficient of the k Gaussian model.

5. The method according to claim 4, wherein p(x; aₖ, Sₖ, πₖ) is the probability density of the Gaussian mixture model, and the method further comprising:
labeling a skin pixel region and a non-skin pixel region of an RGB sample image, and obtaining a skin pixel sample and a non-skin pixel sample;
converting the skin pixel sample and the non-skin pixel sample from the RGB color space to the r-g color space; and
using an expectation maximization algorithm to calculate out the parameters of the skin pixel Gaussian mixture model and the parameters of the non-skin pixel Gaussian mixture model according to the skin pixel sample and the non-skin pixel sample after color space conversion, wherein the parameters include aₖ, Sₖ and πₖ.

6. An electronic device for skin color detection, comprising:
at least one processor; and
a memory communicably connected with the at least one processor for storing instructions executable by the at least one processor, wherein execution of the instructions by the at least one processor causes the at least one processor to:
read an RGB image and convert the RGB image from an RGB color space to an r-g color space, and obtain an image to be detected;
traverse and read each pixel in the image to be detected, and calculate a first probability density of the pixel under a skin Gaussian mixture model and a second probability density of the pixel under a non-skin Gaussian mixture model according to a pre-established Gaussian mixture model; and calculate the posteriori probability of the pixel belonging to a skin region according to the first probability density and the second probability density of the pixel; and
attribute the pixel to the skin region when determining that the posteriori probability is greater than a preset posteriori probability threshold.

7. The electronic device according to claim 6, wherein the step to convert the RGB image from the RGB color space to the r-g color space further comprises:
convert the RGB image from the RGB color space to the r-g color space adopting a formula as follows:
$$\begin{matrix}r = \frac{R}{R + G + B} \\ g = \frac{G}{R + G + B} \\ b = 1 - r - g\end{matrix}$$
wherein, R is the red value of the pixel, G is the green value of the pixel, and B is the blue value of the pixel; r, g and b are the corresponding color values of the pixel after conversion respectively.

8. The electronic device according to claim 6, wherein the step to calculate the posteriori probability of the pixel belonging to the skin region according to the first probability density and the second probability density of the pixel further comprises:
calculate the posteriori probability adopting a formula as follows:
$$P = \frac{{p}_{skin}}{{p}_{skin} + {p}_{non \text{-} skin}}$$
wherein, P is the value of the posteriori probability, pₛₖᵢₙ is the first probability density; and pₙₒₙ₋ₛₖᵢₙ is the second probability density.

9. The electronic device according to claim 8, wherein the step to calculate the first probability density of the pixel under the skin Gaussian mixture model and the second probability density of the pixel under the non-skin Gaussian mixture model according to the pre-established Gaussian mixture model further adopts a formula as follows:
$$p ( x ; {a}_{k} , {S}_{k} , {π}_{k} ) = {\sum }_{□ = 1}^{□} {π}_{k} {p}_{k} ( □ ) , {π}_{k} \geq 0 , {\sum }_{□ = 1}^{□} {π}_{k} = 1 , \\ {p}_{k} ( □ ) = ϕ ( x ; {a}_{k} , {S}_{k} ) = \frac{1}{{( 2 □ )}^{□ / 2} {\vert {S}_{k} \vert}^{1 / 2}} exp \{ - \frac{1}{2} {( □ - {a}_{k} )}^{□} {S}_{k}^{- 1} ( □ - {a}_{k} ) \}$$
wherein, p(x; aₖ, Sₖ, πₖ) is the probability density of the Gaussian mixture model, x belongs to a d-dimension euclidean space, m is the preset number of Gaussian models, pₖ(x) is the probability density of the k Gaussian model, aₖ is the mean vector of the k Gaussian model, Sₖ is the covariance matrix of the k Gaussian model, and πₖ is the weight coefficient of the k Gaussian model.

10. The electronic device according to claim 9, wherein the at least one processor is further caused to:
label a skin pixel region and a non-skin pixel region of an RGB sample image, and obtain a skin pixel sample and a non-skin pixel sample;
convert the skin pixel sample and the non-skin pixel sample from the RGB color space to the r-g color space; and
use an expectation maximization algorithm to calculate out the parameters of the skin pixel Gaussian mixture model and the parameters of the non-skin pixel Gaussian mixture model respectively according to the skin pixel sample and the non-skin pixel sample after color space conversion, wherein the parameters include aₖ, Sₖ and πₖ.

11. A non-transitory computer-readable storage medium storing executable instructions that, when executed by an electronic device with a touch-sensitive display, cause the electronic device to:
read an RGB image and convert the RGB image from an RGB color space to an r-g color space, and obtain an image to be detected;
traverse and read each pixel in the image to be detected, and calculate a first probability density of the pixel under a skin Gaussian mixture model and a second probability density of the pixel under a non-skin Gaussian mixture model according to a pre-established Gaussian mixture model; and calculate the posteriori probability of the pixel belonging to a skin region according to the first probability density and the second probability density of the pixel; and
attribute the pixel to the skin region when determining that the posteriori probability is greater than a preset posteriori probability threshold.

12. The non-transitory computer-readable storage medium according to claim 11, wherein the step to convert the RGB image from the RGB color space to the r-g color space further comprises:
convert the RGB image from the RGB color space to the r-g color space adopting a formula as follows:
$$\begin{matrix}r = \frac{R}{R + G + B} \\ g = \frac{G}{R + G + B} \\ b = 1 - r - g\end{matrix}$$
wherein, R is the red value of the pixel, G is the green value of the pixel, and B is the blue value of the pixel; r, g and b are the corresponding color values of the pixel after conversion respectively.

13. The non-transitory computer-readable storage medium according to claim 11, wherein the step to calculate the posteriori probability of the pixel belonging to the skin region according to the first probability density and the second probability density of the pixel further comprises:
calculate the posteriori probability adopting a formula as follows:
$$P = \frac{{p}_{skin}}{{p}_{skin} + {p}_{non \text{-} skin}}$$
wherein, P is the value of the posteriori probability, pₛₖᵢₙ is the first probability density; and pₙₒₙ₋ₛₖᵢₙ is the second probability density.

14. The non-transitory computer-readable storage medium according to claim 13, wherein the step to calculate the first probability density of the pixel under the skin Gaussian mixture model and the second probability density of the pixel under the non-skin Gaussian mixture model according to the pre-established Gaussian mixture model further adopts a formula as follows:
$$p ( x ; {a}_{k} , {S}_{k} , {π}_{k} ) = {\sum }_{□ = 1}^{□} {π}_{k} {p}_{k} ( □ ) , {π}_{k} \geq 0 , {\sum }_{□ = 1}^{□} {π}_{k} = 1 , \\ {p}_{k} ( □ ) = ϕ ( x ; {a}_{k} , {S}_{k} ) = \frac{1}{{( 2 □ )}^{□ / 2} {\vert {S}_{k} \vert}^{1 / 2}} exp \{ - \frac{1}{2} {( □ - {a}_{k} )}^{□} {S}_{k}^{- 1} ( □ - {a}_{k} ) \}$$
wherein, p(x; aₖ, Sₖ, πₖ) is the probability density of the Gaussian mixture model, x belongs to a d-dimension euclidean space, m is the preset number of Gaussian models, pₖ(x) is the probability density of the k Gaussian model, aₖ is the mean vector of the k Gaussian model, Sₖ is the covariance matrix of the k Gaussian model, and πₖ is the weight coefficient of the k Gaussian model.

15. The non-transitory computer-readable storage medium according to claim 14, wherein the electronic device is further caused to:
label a skin pixel region and a non-skin pixel region of an RGB sample image, and obtain a skin pixel sample and a non-skin pixel sample;
convert the skin pixel sample and the non-skin pixel sample from the RGB color space to the r-g color space; and
use an expectation maximization algorithm to calculate out the parameters of the skin pixel Gaussian mixture model and the parameters of the non-skin pixel Gaussian mixture model respectively according to the skin pixel sample and the non-skin pixel sample after color space conversion, wherein the parameters include aₖ, Sₖ and πₖ.
